(19) United States
(12) Patent Application Publication
(10) Pub. No.: US 2004/0236669 A1
(43) Pub. Date: Nov. 25, 2004

(54) Method and system for automated electronic trading in financial matters

(75) Inventors: John Van Horst, Simi Valley, CA (US); Josip Papic, Novo Mesto (SI); Mitja Sepetavc, Novo Mesto (SI)

Correspondence Address: DARBY & DARBY P.C., P. O. BOX 5257, NEW YORK, NY, 10150-5257, US

(73) Assignee: Trade Robot Limited

(21) Appl. No.: 10/826,877

(22) Filed: Apr. 16, 2004

Related U.S. Application Data
(60) Provisional application No. 60/464,057, filed on Apr. 18, 2003.

(51) Int. Cl. G06F 17/60

(52) U.S. Cl. 705/37

(57) ABSTRACT

Automated electronic trading is provided by the cooperation of various modules that generate trade orders and transmit the trade orders to the appropriate broker platform for execution of the trades. The trade orders are generated based on trade strategies and other settings that are determined by the trader or client or combination. These tools enable a client to set up automated trading based on trade orders generated remotely by a professional trader using a vendor module to manage multiple trading strategies and market data inputs.

This patent application claims the priority under 35 U.S.C. §119(e) of U.S. provisional patent application No. 60/464,057, which is incorporated herein by reference.

### FIELD OF THE INVENTION

This invention relates to generating and executing electronic trades in a financial market using automated and remote control applications.

### BACKGROUND OF THE INVENTION

Investors who want to trade within a financial market e.g., stocks, bonds, commodities, and the inter-bank currency market (foreign exchange), etc., generally provide instructions to a broker (dealer) who in turn executes the trades. A broker is a person or entity that acts as an intermediary between a trader or investor, and the financial exchange or market for the purchase and sale of financial instruments. Conventionally, investors provided trade instructions to their brokers over telephone or other individual communication, e.g., e-mail. With the advent of the Internet, trading platforms have been developed to provide price quotes and other trading information for a particular market and to enable investors to place their trade orders or instructions directly with the broker using the platform software and communicating via the Internet. For example, FXCM is a broker in the foreign currency market and maintains a broker trading platform that is accessible and can be downloaded via the Internet.

Investors face many obstacles in trading financial instruments in general, and foreign currencies in particular. Given that the exchanges are in different countries and different time zones, the potential period for trading per day can be very long or unusual hours depending on what market or exchange is traded around the world, especially in the 24-hour foreign exchange (spot) market. Thus investors are subject to fatigue. In addition, there are human limitations on the number of markets or strategies that an individual investor can track and follow. Also, there can be a vast amount of information (real-time and historical) and analysis tools to take into consideration when determining trade strategies. The term “trading strategy” is a term of art well known in the industry. Trading strategies generally include a set of rules, conditions, and/or pattern that an investor uses to make a buy or sell decision of a financial product or instrument. For example a strategy may describe a specific market condition such as when the price of a certain currency pair is lower than the lowest price over the last month and use the condition in a rule such as generate a buy order for that currency pair when the condition is satisfied.

A trading strategy can be based on discretionary rules, economic indicators, political situations, technical analysis, breaking news, etc. Many investors base their trading decisions on technical analysis, such as a study of price action. Many indicators have been developed for the study of price action. A technical investor typically uses a charting software combined with a data-feed that will create charts of financial products or instruments, such as currencies, going back over a period of time using historical data, and watch the charts develop in real time using real-time data.

In the foreign currency market, there are many commercial charting software programs, such as, Trade Station 2000i, e-Signal, FX-Trek, Ensign, etc. Many of these charts have built-in (predetermined, static) statistical indicators that will allow the investor to analyze charts. An indicator can be applied to a chart to help predict the price action. Examples of some indicators are moving averages, cycles, or oscillators that indicate when a market is overbought or oversold. There are many ways to use and create indicators limited only by the imagination. Many of these programs also allow an investor to program his own indicators, and incorporate the custom indicators and rules into trading strategies. The resulting trading strategies provide actual buy and sell signals generated when the custom indicators satisfy the investor's conditions and trading rules.

When the charting program generates a “buy” or “sell” order based on the trading strategy/system, the investor must decide whether to follow that instruction. If the trade is to be executed, the investor must communicate the trade order to his broker. The investor may contact his broker by phone to place the orders, or place the orders by computer using an online trading platform via the Internet or other network communication.

Trading strategies are developed for a particular charting program; they are not generic. Trading strategies are typically only operable with the charting program for which it was designed. The suppliers of the charting programs may offer some trading strategies with their program. In addition, there are vendors that develop trading strategies designed for particular charting programs. Some investors develop their own trading strategies and then act as vendors who sell their trading strategies other investors for use with the particular charting program.

In general, the charting programs and trading strategies improve trading conditions for the investor by simplifying the decision process for placing trades. Nevertheless, these tools still require significant investor involvement. Typically the investor still needs to subscribe to a data feed source for historical and real-time data. The investor also needs to purchase a charting software program and create his own trading strategy or purchase vendor-supplied trading strategies. The investor still needs to review all the information provided by the charting program to determine which trades to execute. Finally the investor must still communicate the one or more trading orders to the broker platform for execution.

Statistical formulas show that risk depends on the diversification of capital and/or the trading of a combination of different strategies. Incorporating more trading strategies and participating in more markets (trading more currencies) can reduce risk and increase the potential for substantially higher gains. However, the more charts, strategies and markets, the greater the physical, psychological and emotional factors that limit the investor's capability to trade effectively.

What is needed is a system and method for accommodating sophisticated strategies, managing multiple trading strategies, and processing a large number of trades, etc., to effectively alleviate the stress on the investor without compromising the value of the investor's experience and discretion. The invention satisfies these and other needs. Other benefits of the present invention include full access to strategy performance evaluation, standardization of trading strategies and trading information, and simplification of configuration and control over automated trade execution.

The terms trader, vendor, client, and investor are used loosely to refer to a person or entity involved in trading and not intended to convey any limitation.

### SUMMARY OF THE INVENTION

The invention is a method and system for facilitating automatic electronic trading in a financial market. According to the invention, a vendor module receives deal rates and applies one or more trading strategies to the dealing rates to generate trade orders. Trading information includes some or information that comprise a trade order and optionally additional information about the trade, strategy, market, or logistics. The trading information is transmitted via a server module to a client module. The client module applies the client settings to the received trading information to select trade orders, which are automatically transmitted to a broker server for execution on the client's account. The vendor module also applies vendor to select trade order, which are automatically transmitted to a broker server for execution on a vendor account.

### BRIEF DESCRIPTION OF THE DRAWINGS

FIG. 1 shows a block diagram of the components used with the vendor module in the preferred embodiment of the invention;

FIGS. 2A-D show block diagrams of various configurations of the components used with the vendor module in the preferred embodiment of the invention;

FIG. 3 shows a display of information concerning trading activity in accordance with the preferred embodiment of the invention;

FIG. 4 shows another display of information concerning trading activity in accordance with the preferred embodiment of the invention;

FIG. 5 shows a display of historical information concerning trading activity in accordance with the preferred embodiment of the invention;

FIGS. 6A-B show various displays for facilitating the input of settings in accordance with the preferred embodiment of the invention;

FIGS. 7-8 show various displays of information concerning trading strategies and trading systems in accordance with the preferred embodiment of the invention; and

FIG. 9 shows a block diagram of the interaction between modules in accordance with the preferred embodiment of the invention.

### DESCRIPTION OF PREFERRED EMBODIMENT

The present invention is a system and method that provides traders with a variety of tools for electronic trading in financial markets including automated trading capability. The preferred embodiment is described with respect to its application in the foreign currency market. It should be understood that the invention is not limited to such market.

The automated trading capability is particularly useful because it can operate continuously without the trader's intervention, execute trade strategies objectively, and manage multiple strategies concurrently which potentially generate significant volume of trades. The invention also provides an environment and support for combining strategies into trading systems thereby lowering risk and increasing returns. The trader's clients can connect to the trader's platform and receive all the trade information generated by the trader's strategies and system. The client can also set up the automated trading whereby the trade orders (generated by the trader's system) are transmitted directly into the client's account with the broker via the Internet. Once the process is set up, the trading will take place without any required action by the client. This arrangement eliminates the need for the client to obtain expensive charting programs and data-feed. Thus the invention overcomes the human limitations systemic of trade execution such as fear, greed, fatigue, and psychological factors that affect investors during trading.

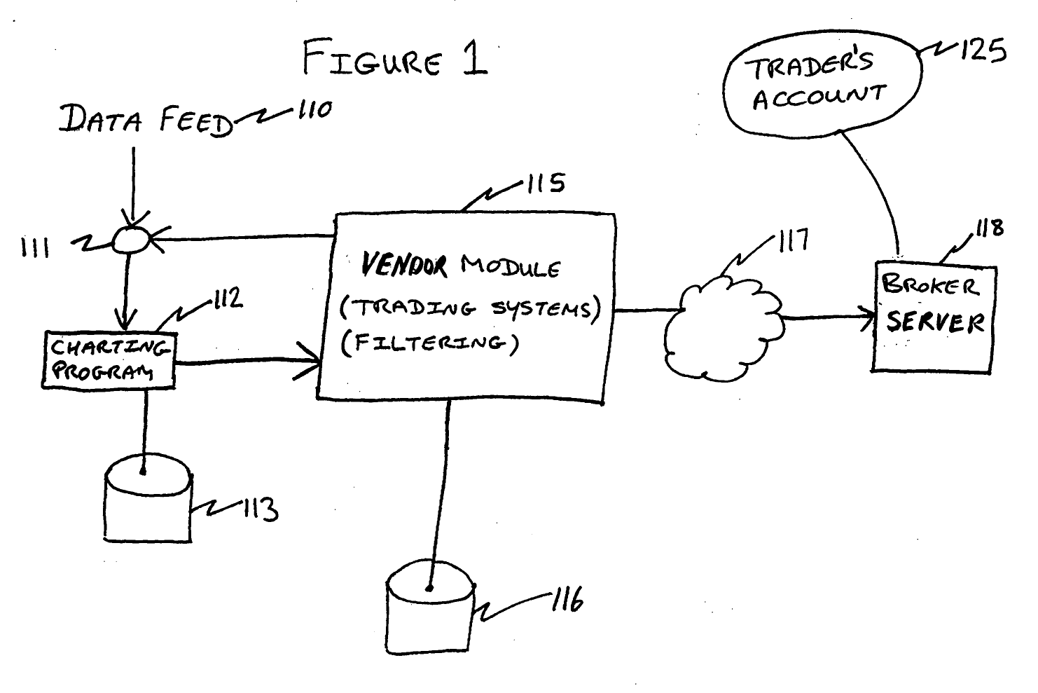

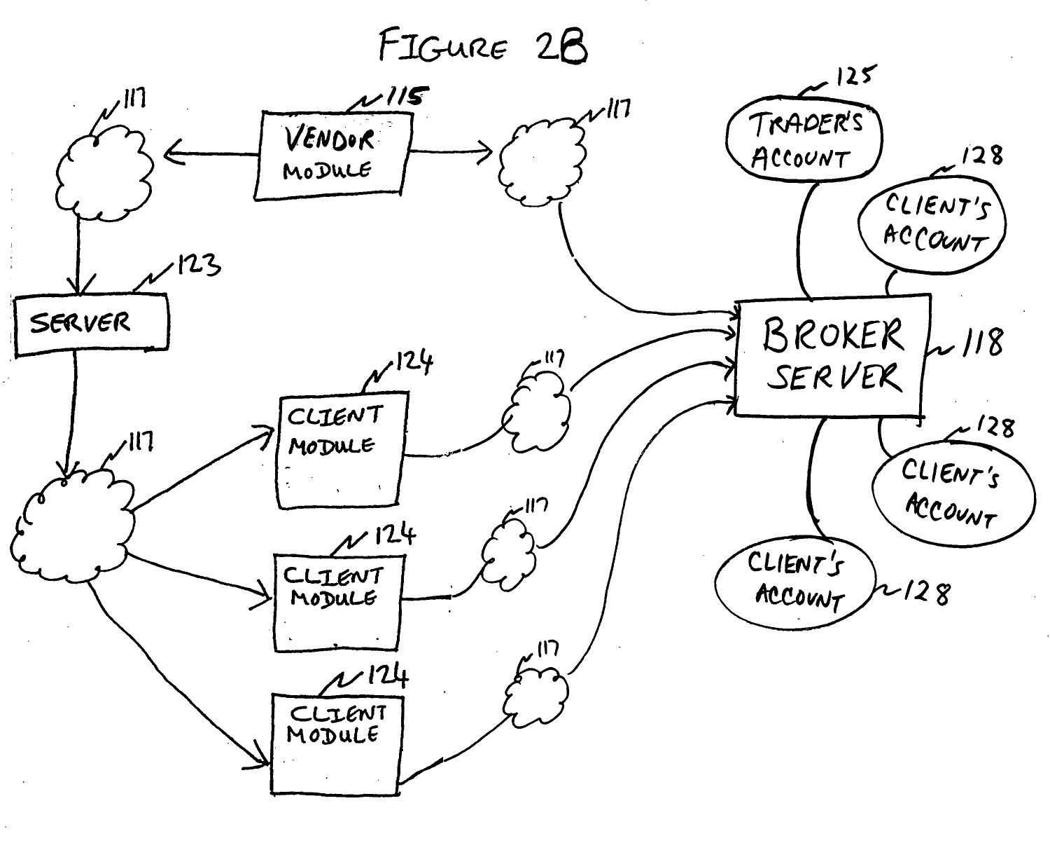

With reference to FIG. 1, the vendor module 115 enables a trader to develop and manage a trading system using any number of trading strategies and automatically transmits trade orders to a broker server 118 for execution. The broker server is computer hardware and/or software maintained by the broker for investors (traders, clients, etc) to remotely access and make transactions on the investors' accounts. A live data feed 110 provides dealing rates, i.e., current buy and sell prices for currencies being traded in the market. The vendor module may use a charting program 112 to apply the trading strategies/systems and generate potential trade orders. In this embodiment, the charting program and vendor module each maintain databases 113 and 116, respectively, to track all the trading information. The trader manages the trade orders using the vendor module 115 by selecting strategies and/or combining trading strategies into trading systems, which are used in conjunction with the charting program. In addition, the trader sets parameters for filtering the potential trade orders generated by the trading system in the charting program. Based on the trader's various settings and parameters, the vendor module automatically transmits select trading orders to the broker server for execution on the trader's account 125. The vendor module is connected to the broker server using standard communications or network connection 117, e.g., the Internet.

In addition to providing automated trading on the trader's account, the vendor module may be used to service clients by providing the clients with information resulting from the trader's trading strategies/systems. This business version of the vendor module is particularly suitable for vendors of charting programs or traders having custom developed strategies and trading systems.

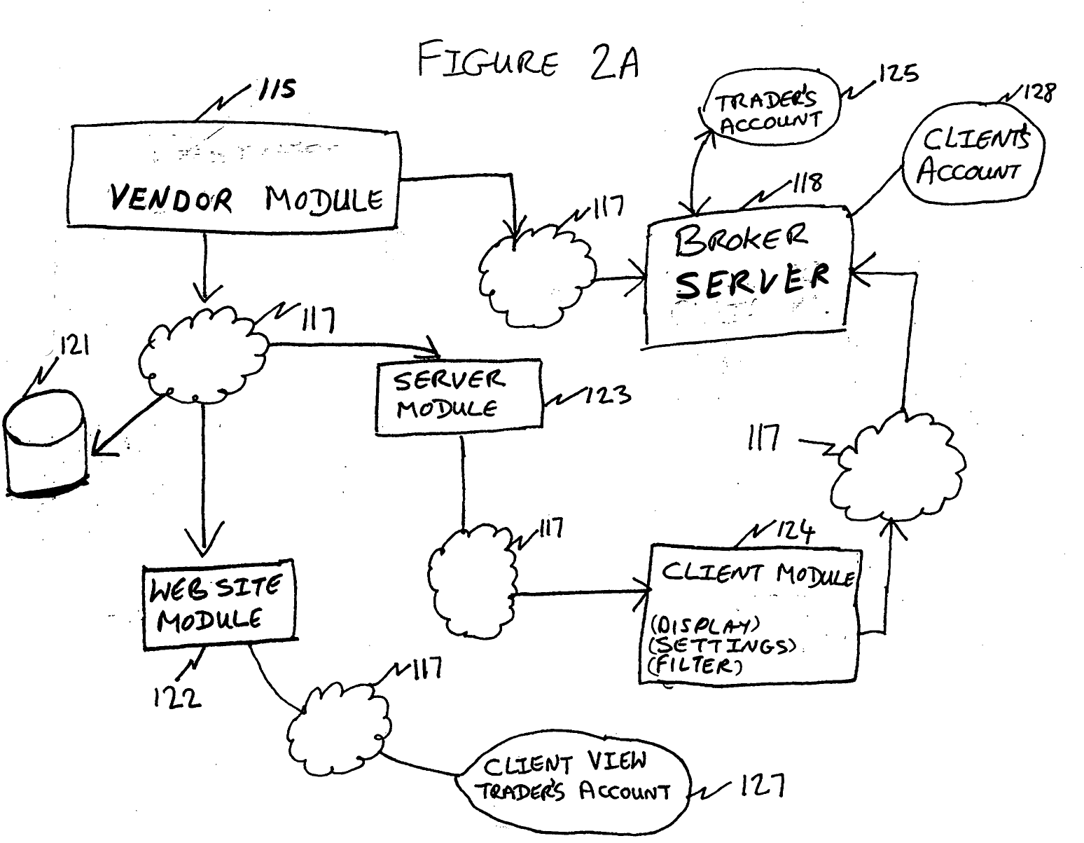

As illustrated in FIG. 2A, the vendor module 115 enables the trader/vendor to provide various trading information to a client (or clients) remotely. The client can access and view (127) the activity, performance and history of the trading strategies/systems managed by the trader/vendor on the trader's account. This access is enabled by the website module 122. The information for every trade that the vendor module authorizes for execution on the trader's account 125 is transmitted to the website module. The website module maintains a database for storing a record of each trade transaction. The client may use conventional Internet browsing applications to access the website.

Furthermore, using the client module 124, the client can set up automated trading, to be executed on its own account, based on the trading system managed by the trader/vendor using the vendor module. This client access is enabled by the server module 123. The information for every trade authorized by the vendor module for execution on the trader's account is transmitted to the server module, which forwards the trading information to the client's client module. The server module is computer hardware and/or software that facilitate communication between modules. The client can impose some control over the automated trading by adjusting the settings and filters. For each trade received from the vendor module, if the trade satisfies the client's settings and filters, the client module automatically transmits the trade to the broker server for executing the trade on the client's account 128. This way the client can actively engage in the market, without having a live data feed and charting programs and does not need the expertise in managing charting and strategies; the client only needs an account with a broker. The client module uses the real-time trading information received from the server module (generated by the vendor module), selects trades according to the client's settings and filter parameters, and transmits the selected trades to the appropriate broker for automatic execution.

To support client access, the vendor module 115 includes the functions for communications with the server module 123, website module 122, and database 121. The dealing rates received by the vendor module (from the data feed or broker) are stored in the database 121. The history of dealing rates is used for retroactive performance analysis of a trading strategy or trading system from within the charting program.

If the vendor module operates with more than one client, then each client uses a separate instance of the client module (124), each are connected to the vendor module via the server module 123, and each has access to the web service module 122. As illustrated in FIG. 2B, if the vendor using the vendor module 115 has three clients, each client sets up its own client module 124 (each located anywhere and connecting through the same or various communication methods) to communicate with the server 123. Each client module independently receives the same trading information from the server; the information having been generated by the vendor module. Each client module applies the client's settings and filters to determine which trades to forward (using whatever it established for communication) to the broker for execution. The trades for execution may therefore be different for each client the broker server receives the trade orders and executes the trade on the appropriate client account 128. In the example illustrated, there are three clients, each having its own account 128 at the broker server.

The automated trading system may be used with any broker having a server to support the connection for receiving trading orders. In the preferred embodiment, the cooperating vendor module(s) and client module(s) use the same broker, albeit the trades may be executed on separate accounts. In a further embodiment, the subject trading system is configured to handle the communications for more than one broker server thus accommodating clients and traders having accounts with different brokers (and thus different broker servers).

Some vendors/traders may want to connect to another vendor module to benefit from the other trader/vendor's trading strategies/systems and offer its own serves to clients. Thus, as illustrated in FIG. 2C, the sub-vendor module 130 established a connection with the vendor module 115, via the server 123 in a manner similar to the client modules 124. The trading information including trade orders generated by the vendor module 115 is transmitted to the sub-vendor module 130. Like the client module 124, the sub-vendor module 130 can impose its own settings on the received trading information and set up automated trading on its own account 129 via the broker server 118. However unlike a client module, the sub-vendor module also has all the functionality and control available on a vendor module. The sub-vendor module 130 may have its own live data feed, charting program, trading strategies, and trading systems. The sub-vendor module can also transmit trading information including its own selection of trade orders via the server module 123′ to the sub-vendor's clients. This server 123′ may be the same as or different from the server 123 used by the source vendor module 115. The server forwards the trade information to the sub-client modules 131 associated with the sub-vendor's clients. Depending on the sub-client's settings, trade orders are automatically transmitted to the broker platform for execution on the sub-client's account 132. The communications between the various modules and the broker server are separate and independent even though in FIG. 2C a single centered cloud is used to indicate many various communication lines.

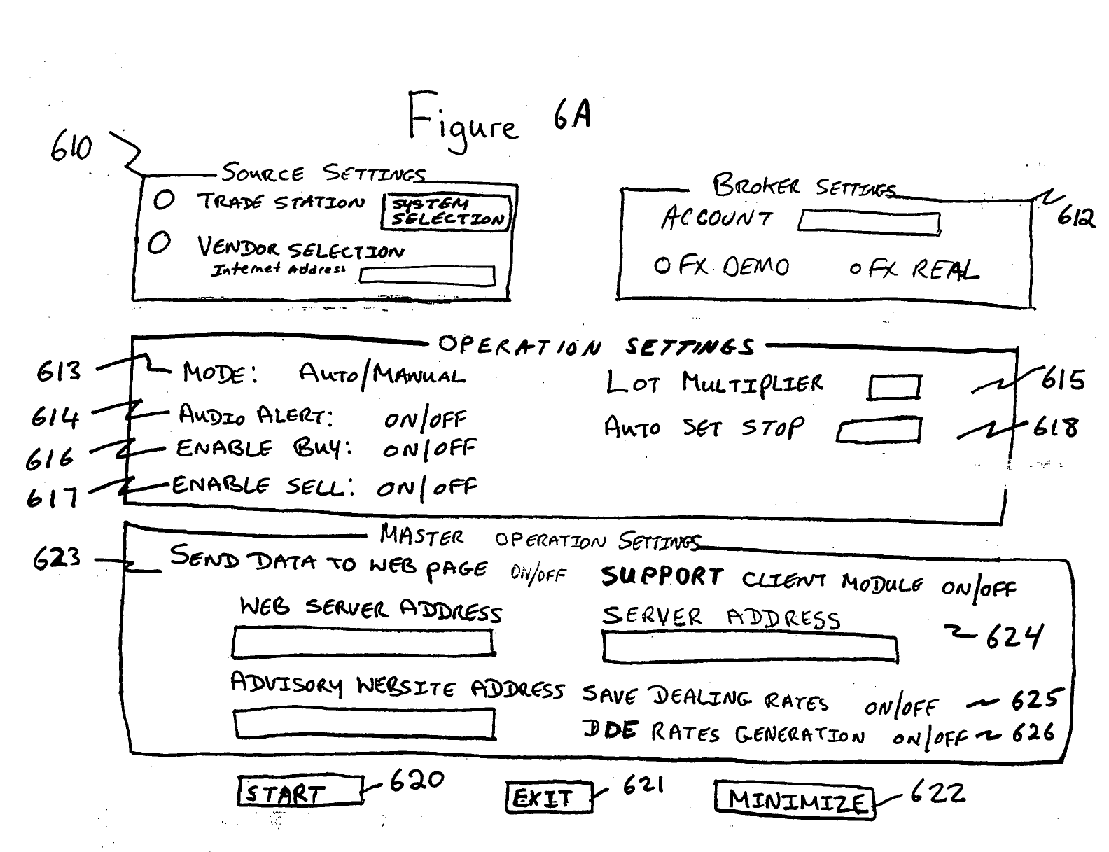

The vendor module may also be used to manage a trading fund, e.g., a mutual fund, instead of an individual account. As illustrated in FIG. 2D, the trades generated by the vendor module 115 are executed on the fund account 126. Optionally, the fund manager can make the fund information available to clients using the website module 122 (enabled by the send data to web page setting 623, illustrated in FIG. 6A. Clients can access and review (114) the activity, performance and history of the fund via the supported website.

A trader/vendor may also implement a discretionary trading system using any configuration of the modules. For example, referring to FIG. 2A, instead of relying on a selected or developed mechanical trading system, the trader may manually enter one or more specific trade orders, referred to as discretionary trades. These trades will be processed and executed accordingly as if they were generated by a trading system. The discretionary trades can then be sent to the client modules and then to the broker server.

The configuration of connections between the various components and modules may be varied, as is well known in the art, without deviation from the invention described. All features and functionality described with respect to the vendor module, also apply the vendor module. Each of these components is described in more detail below.

The vendor module is a software application for managing trading systems and automated trading. It uses a trading system within the charting program as a source of trading information which in turn uses a data feed for input of real-time dealing rates. Dealing rates is real-time market data including price quotes for buy or sell of the various currencies. Banks or other companies provide the data feed as a service, typically for a fee on a subscription basis. The data feed for the charting program is provided by standard communications, e.g. telephone lines or network connection, e.g., the Internet. For example, using a dedicated modem line, the service can continuously or regularly provide current trade data (price quotes, dealing rates) to the charting program. Alternatively, the data feed may be supplied by the broker, i.e. the price quotes used by the broker are transmitted through the vendor module to the charting program. As illustrated in FIG. 1, if the data feed is supplied by the broker, the vendor module 115 provides the pricing to the charting program 112. In another configuration the dealing rates are tapped from the broker and sent through the vendor module to the database 121 which then streams the data to the charting program 112. This arrangement is set by indicating save dealing rates 625 and DDE rates generator 626, as illustrated in FIG. 6A.

The real-time market data from the subscription service or broker platform (direct or via database) is typically not in the format required by the charting program, therefore the data feed 110 is processed through a converter 111 that provides the format suitable for the applicable charting program 112. For example, a DDE converter (dynamic data exchange protocol) is used for Ensign and FxTrek; XPO converter is used for Trade Station. (Some vendors of charting programs use specially tailored protocols to prevent unauthorized use of their data.)

The charting program may be operated on the same computer or local network as the vendor module. The charting program may be incorporated in the vendor module. The charting program and vendor module may share databases. The charting program may also be located remotely in which case the vendor module connects to the charting program using the appropriate standard communications or network connection.

The charting program uses the market data (provided via the data feed) and generates trade orders based on the implemented trading strategies/systems. To implement a strategy, the strategy/system is defined in terms of one or more rules that can be followed or executed by the charting program. Coding the trading strategies/systems to be implemented with a charting program is an involved process. In addition to the trading strategies/systems provided together with the charting program, there are many trading strategies/systems developed by vendors (independent of the charting program provider) that may be separately obtained and incorporated. Some traders design and implement their own trading strategies. The system manager (described below) is a tool that assists the trader in the tasks of devising and managing the strategies and trading systems. Traders may also implement trading strategies directly using the vendor module without a separate charting program.

The trader may have more than one charting program which is accessible and operable from the trader's computer. However in the preferred embodiment, the trader uses only one charting program as the source of input for the vendor module. Only one charting program is needed because any strategies and trading systems that the trader wants to use can be incorporated or implemented with the one charting program. In a further embodiment, more that one charting program concurrently generates trades for the vendor module.

To begin operations, the trader must select a charting program and develop or obtain one or more trading strategies. The system summary module is a tool that provides graphical display and performance reports of the various available strategies and systems (individually and collectively), including those obtained from a vendor and/or those developed by the trader.

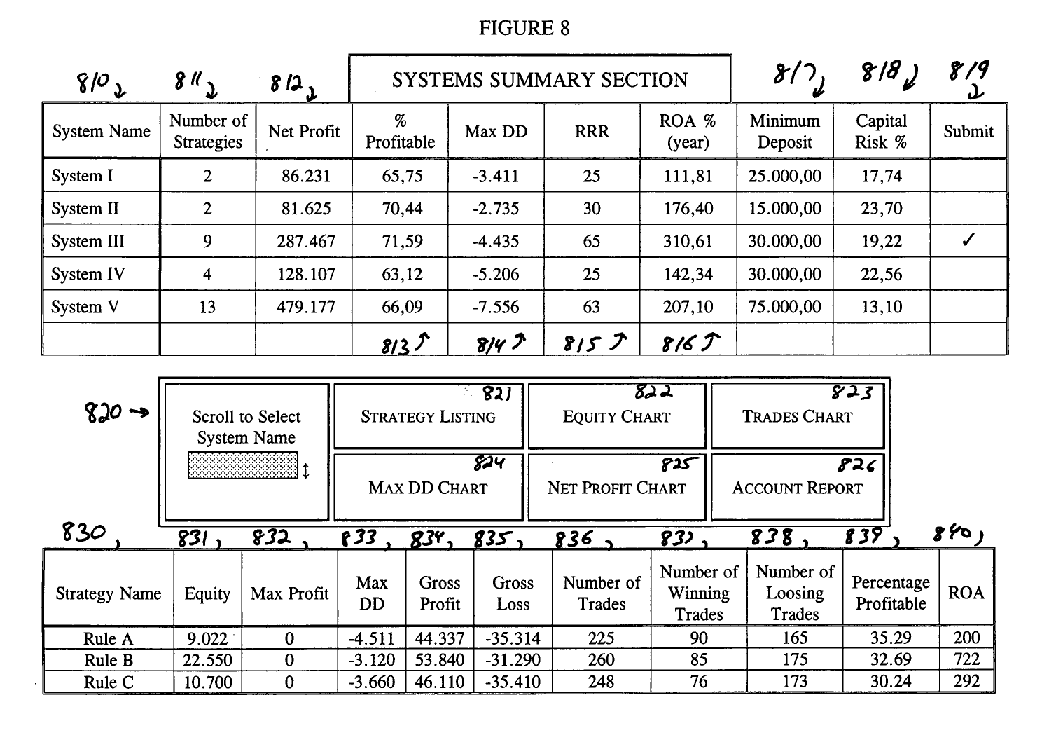

As illustrated in FIG. 8, the system summary shows information about each available trading system including, e.g., the system name 810, number of strategies 811, net profit 812, profitability (percentage) 813, maximum draw down (DD) 814, real rate of return (RRR) 815, return on account (ROA) (percentage per year) 816, minimum deposit 817, and capital risk (percentage) 818. The system name is the name given for the collection of one or more strategies, which are pre-selected (e.g., by the trader/vendor) to ensure the best results, e.g., in comparison with the minimum money deposit. Number of strategies indicates the number of strategies that a system contains. Net profit ($) is the hypothetical profit a system generated based on a predetermined historical testing period. Profitability (%) indicates the percentage of winning trades compared with all trades in the trading system for a past testing period. Max DD is the largest draw down that occurred over the past testing period. (A draw down is an intermittent reduction in capital. As trades are executed on an account, the balance rises and falls. Over time the account should be profitable, however if at some time the balance is less than the initial capital it is called draw down.) RRR is the total net income of the system divided by the maximum intra-day draw down; the higher the number the more robust the system is. ROA (%) is the average Return On Account based on the past testing period (year) and compared with the minimum deposit. Minimum deposit is the suggested minimum account deposit needed to trade this system based on the past performance data to avoid a margin call and to achieve optimal profit. Capital risk (%) is the percentage of loss exposure based on past performance data in comparison with the minimum money deposit.

The system summary also supports charts for viewing more detailed information for a strategy system (indicated at 820), including, e.g., a listing of the strategies in the system (and the performance statistics of each individual strategy) 821, an equity chart 822, trades chart 823, maximum draw down chart 824, monthly net profit chart 825, and an account report 826. The details per strategy include, e.g., strategy name 830, equity 831, maximum profit 832, maximum draw down 833, gross profit 834, gross loss 835, number of trades 836, number of winning trades 837, number of loosing trades 838, percentage profitable 839, and return on account 840. From the list provided by the system summary module, the trader selects the desired strategies and trading systems, which are submitted (819) to the vendor module.

Once the strategies are set up, the charting program applies those strategies and trading systems to the price quotes (from the data feed) thus generating proposed trade orders. The charting program manages the proposed trade orders in a database. The vendor module checks the proposed trade orders in the charting program's database and maintains its own database of trade orders and other trading information. The vendor module updates the database to indicate, for example, when trades orders are active, in open position, filled, or cancelled.

Using the vendor module, the trader selects the desired settings and filter parameters. An example of settings for the vendor module is illustrated in FIG. 6A. The trader may indicate source information, broker information and operation conditions. As described above, the trader specifies the charting program and trading strategies/systems to be used for generating trades. At 610, the trader selects a charting program, e.g., Trade Station as well as selects and configures his strategies for use with the vendor module. Then by linking to the system selection page in the vendor module, the trader may view a listing of the available strategies and systems. The trader may combine one or more strategies into various systems which he can select for use with the vendor module. Alternatively the trader may use a vendor-supplied trading system, which the trader indicates by linking to the vendor's trading systems and strategies. In the embodiment illustrated, to select the vendor, the trader engages the Internet setting and selects the vendor selection button in the source settings of the vendor module to see the selection of available vendors. The trader has the ability to select a system from a variety of vendors. Upon selection of a vendor, the trader can access a summary of the vendor's strategies and trading systems, as illustrated in FIG. 8 described above. To setup the system (initially or to modify the setup), the trader selects from the available charting program and trading strategies/systems or the available vendor's trading systems. Then the trades generated by the selected system(s) will be automatically transmitted to the broker server (in accordance with the trader's other settings and filters).

The broker settings 612 are provided for the trader to indicate which broker server and which account should be used. As with conventional trading, the trader needs to have an account with the broker in order to be fully operational. If the account has sub-accounts the settings would include the field for the specific sub-account. Some brokers offer a demonstration account, which is sufficient for simulating operation, of course without actual money transactions. In one embodiment, the various available broker servers (from one or more brokers) are indicated for the trader's selection. In the illustrated example, the trader is offered a demonstration account and a real account with a single broker. Each account has an initial capital, which fluctuates with trading activity.

Operation settings may include the following: The mode 613 may be set for automatic trading or manual (typically automatic). Audio alerts 614 may be toggled on or off. Lot multiplier 615 indicates the default number lots per trade. (A lot is a predetermined number of units of currency. When a trade is executed for one lot, the transaction is a trade of the predetermined number of units of currency. If a lot multiplier is specified, then each trade involves the multiple of the number of units of the currency.) Enable buy 616 may be toggled on or off to indicate whether the vendor module should limit execution of trades to buy orders, and enable sell 617 may be toggled on or off to indicate whether the vendor module should limit execution of trades to sell orders. Auto set stop 618 indicates the number of points that will automatically trigger placement of a safety stop. (Currencies are typically quoted using five significant digits with the last one or more digit representing the points.) The module also provides commands for starting 620 (running the application module) and exiting 621 (terminating the application module) and minimizing 622 to reduce the display when it is not active. (Additional settings, referred to a filter parameters are described in detail below, with respect to the client module.)

After the settings are configured and the module started (including selection of trading strategy/system and indicating the broker platform), the trader may monitor the transactions using the main activity display.

The vendor module compares the proposed trade orders generated by the trading system and selects the orders that satisfy the trader's settings and filter parameters. For trades that satisfy the trader's conditions, the trading information including trade orders is automatically transmitted to the broker server. For trades that do not satisfy the trader's conditions, the trade order is not transmitted to the broker server.

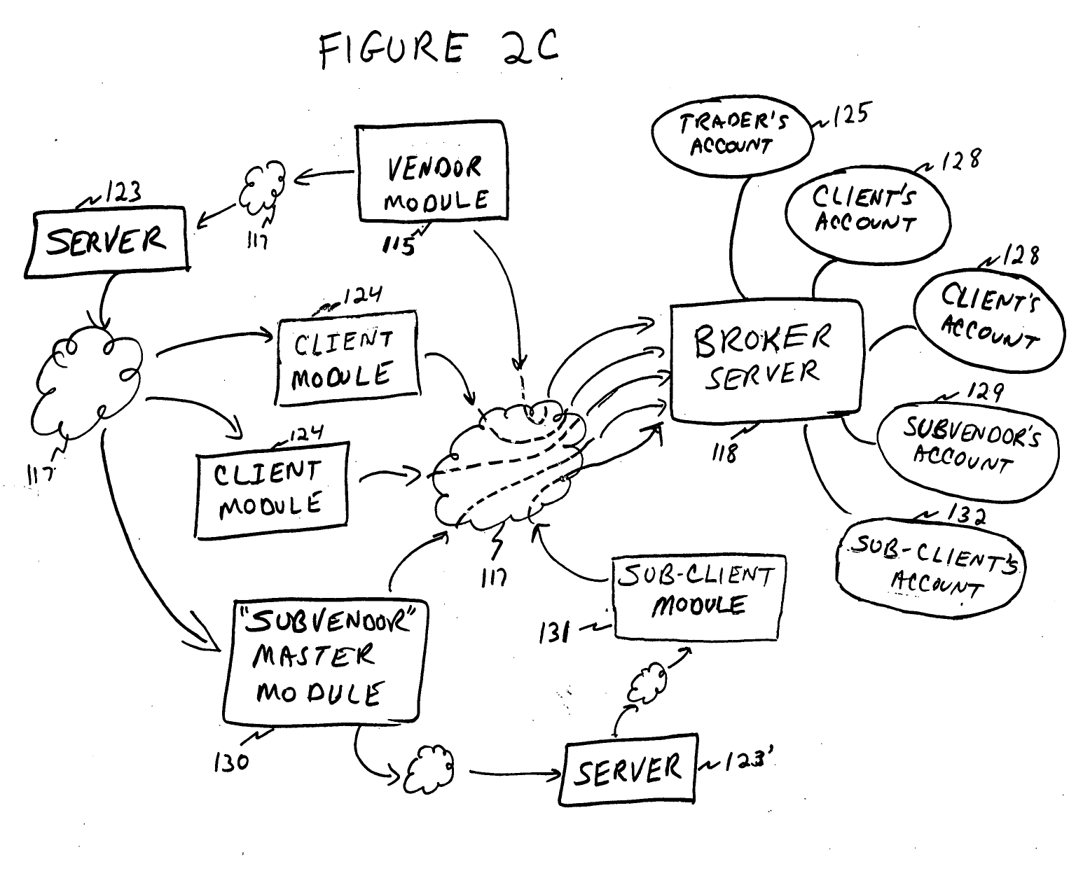

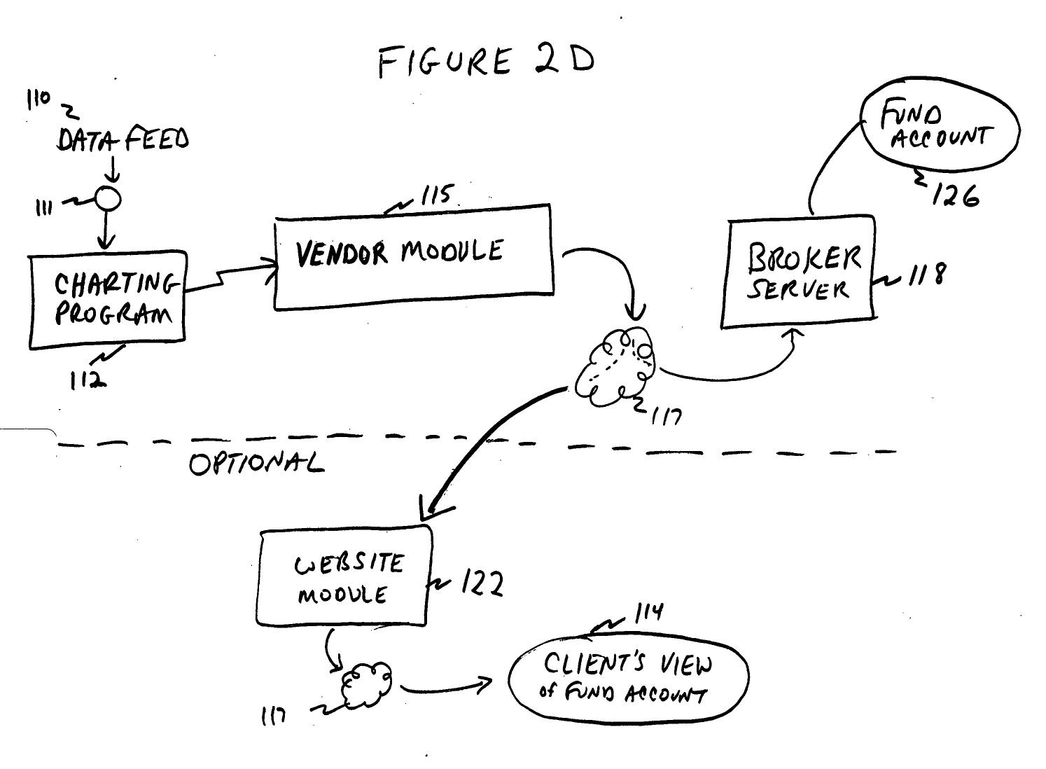

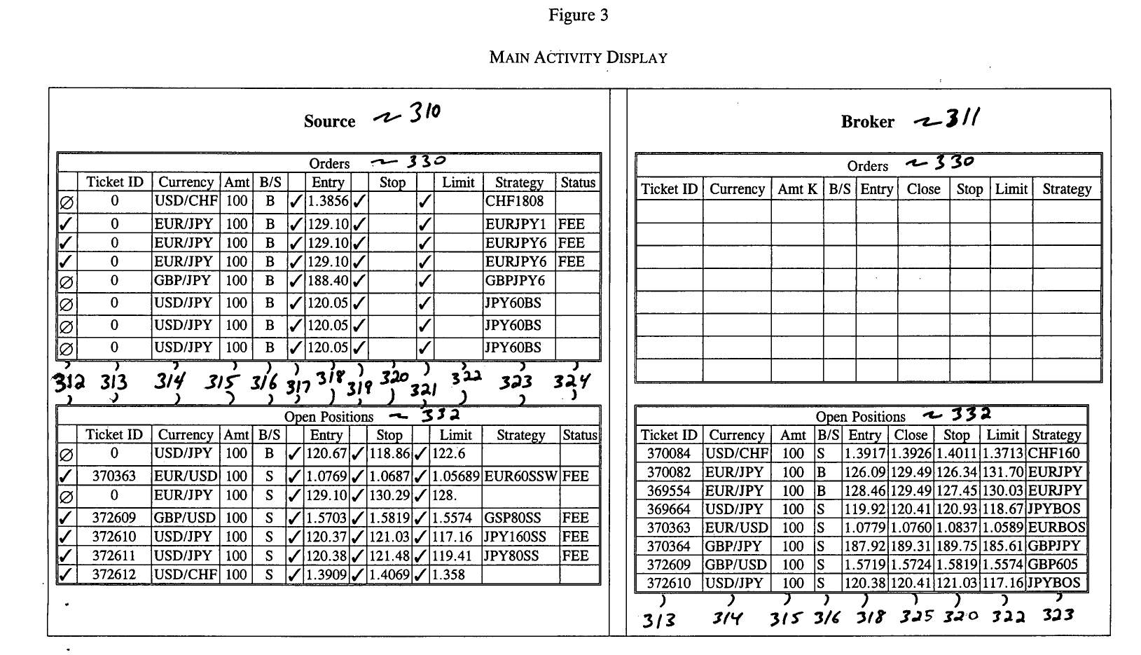

The main activity display shows the transactions as they take place. As illustrated in FIG. 3, one side of the display is labeled source and the other side is labeled broker. The source side shows the trade orders generated by the vendor module based on the charting program and the trader's setting and parameters. The Orders 330 and Open Positions 332 are listed separately. As trade orders are transmitted to the broker server for execution, they appear on the broker side as Orders and/or Open Positions, accordingly.

In the foreign currency market, trade orders consist of a currency pair, buy or sell action, a price level at which the base currency will bought or sold for the second currency. A trade order may also include a Limit which is the target price level when the trader will take his profit (if the exchange rate reaches a predetermined level) as well as Stop which is a protection price level when the trader will protect his investment against loss (if the exchange rate breaks a predetermine level). When a currency is bought and the price appreciates in value, the trader must sell the currency in order to lock in the profit. An Open Position is when the trader bought or sold one currency and has not sold or bought back a sufficient amount to effectively close the position. An Entry Order is defined by either a limit or stop. A Limit Entry Order will be executed if the exchange rate reaches a pre-specified level. A Stop Entry Order will be executed if the exchange rate breaks through the pre-specified level. When an Entry Order is executed, it is no longer an order but becomes an Open Position. Further details of the activity display are provided below.

When the vendor module determines that a trade order should be executed (based on the applied strategies and filters) it transmits to the broker server all necessary information to open and manage that trade. In the foreign exchange market, this information is generally the same for the all brokers. It consist of the name of the two currencies involved in the trade, indication of “buy” or “sell” action, price level to enter the market, target market price level (limit) and protection level (stop). Optionally the limit and stop information is not transmitted along with the trading information for the trade order but held at the vendor or client module. If and when the market price reaches the limit or stop, the module will transmit the appropriate trading information to close the position.

The sequence and timing of transmitting this data may vary depending on the trader's preference and the broker's requirements. The vendor module converts and arranges the trade orders to be executed. The broker server API protocol may require a particular grouping of data as well as the special commands for individual orders so that the server supporting the broker platform can interpret the order orders. For example, the broker platform typically requires the fundamental trade information, e.g., account, currencies, price, limit, and stop, in a particular order. Typically the strategy and other information about the trade that the vendor module tracks is not needed nor provided to the broker.

The broker server confirms the execution of trades and the vendor module indicates the status in its database. For example, when the vendor module sends an order to open a position for a particular currency and the broker server returns a response indicating whether the order was accepted. Similar actions are performed for other transactions. The broker server also provides updated account information to the vendor module showing the result of the trades.

In the business version, as illustrated in FIG. 2A, a vendor can manage his trades directly to his account at the broker server (like a trader using the vendor module) and distribute its trading information to clients so that clients can take advantage of the automated trade execution capability as well as the trader's expertise and trading strategies. The vendor module 115 has additional settings for sending its trading information to the database 121, the website module 122 and the server module 123. (These three components may be co-resident on a server computer.) As illustrated in FIG. 6A, for setting up the website module, the trader enables “send data to web page” and indicates the web server address and advisory website address (623). For setting up the server to support the client module(s), the trader enables “support client module” and indicates the server address (624). The trader may also enable a feature to save the dealing rates (625) in the database (121). The dealing rates may be stored, for example, for purposes of conducting historical analysis as well as for directing these dealing rates to the charting program as a source of live data feed. The trader may also enable DDE rates generator 626 if needed.

The database maintains a history of the trade transactions implemented by the vendor module according to the vendor's trading strategies and settings. The activity for each strategy and trading system is tracked by the database. The historical data of the actual system performance is accessible through the website module.

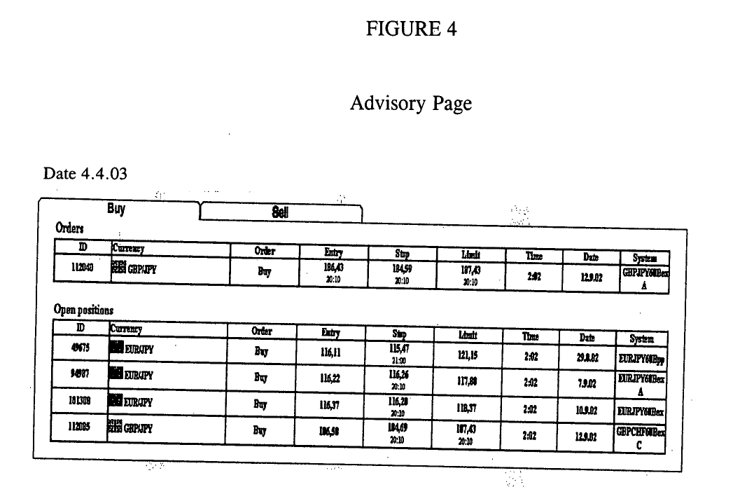

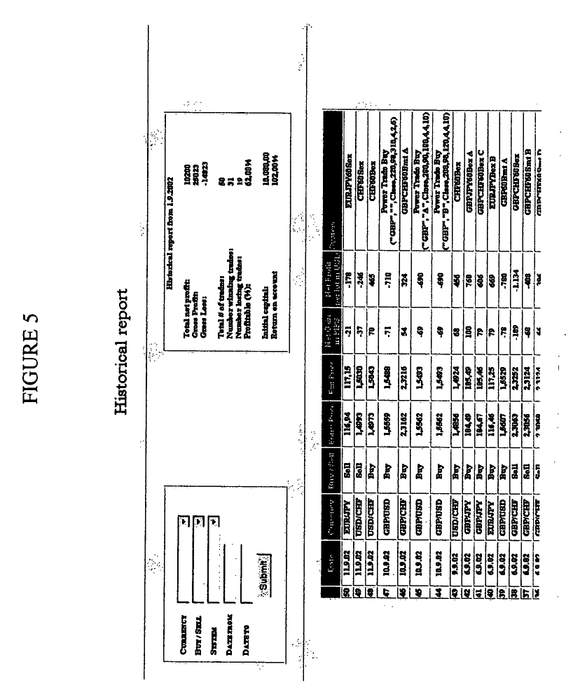

The website module 122 maintains an advisory web page illustrated in FIG. 4 and a page web for accessing historical trading data illustrated in FIG. 5. The web pages are accessible through the Internet using a standard browser. The advisory page is a dynamic web page showing the trades performed using the vendor module. The information is periodically refreshed with the current trading information. Using the advisory web page, clients may access the trade orders suggested by the vendor module and then execute trades using their own means. For example, the client may manually transmit one or more trade orders identified on the advisory web page to (the client's account with) the broker server.

As illustrated in FIG. 4, the presentation on the advisory web page separates buy and sell trade orders. For each order or open position, the following information is provided: ID (identification number); Currency (the pair of currencies); Order (either Buy or Sell order); Entry (the price level to enter the market); Stop (the price level to protect loss); Limit (the target price level or profit we plan to take); Time (time when the trade was placed); Date (the data when the trade was placed); and Strategy (the strategy name that generated the trade).

The client may monitor the performance of the implemented trade strategies using the historical report page. This page is supported by the website module which queries the database for the historical information. As illustrated in FIG. 5, the historical report page provides a summary report of the trader's transactions indicating the total net profits, gross profits, gross loss, total number of trades, number of winning trades, number of losing trades, profitability percentage, initial capital and return on the account.

The details of each trade are also accessible on the historical report page. As illustrated, for each trade executed during some predetermined period, the historical report provides the date of the trade, the currency pair, an indication of “buy” or “sell” transaction, the entry price, the exit price, the net gain in points, net profit per lot in US dollars and the strategy that generated the trade. FIG. 5 shows an example of the performance summary for Sep. 1-11, 2002. This performance shows a total net profit of $10,200.00, or a 102% return on account, based on one lot per trade and initial capital of $10,000 US. The client can also request different historical data by entering a query. For example, the client can limit the report to a currency, buy or sell transactions, a trading system, one or more strategies, and a date range. The client can also request calculation of profits for a specific strategy (or strategies) and period of time. The calculation is performed retroactively using historical data. For these types of calculation, the client may change the deposit (capital) and target profit figures.

Using the client module 124, the client (having an association with the vendor) receives all the trade information generated by the vendor module applying the vendor's strategies and trading systems. The client has access to the web server pages and can select a system directly from the vendor's system summary web page as illustrated in FIG. 8 and described above. The client has the ability to select systems from many different vendors, and to change from one vendor to another. The client (having an account set up with a broker) may then set the client module to automatically execute the trades as they are received from the vendor's vendor module. In addition the client has the option of imposing his own conditions on the automated trading. Thus the client module limits the automatic execution to those trades that satisfy the client's conditions.

A client may monitor its account information using the trading platform (user interface) supported by the broker. Clients my keep the trading platform “open” concurrently with the client module for convenient reference to his account. However, opening the broker trading platform interface is not required, as long as the client module can connect to the broker server.

As illustrated in FIG. 3, the main activity display dynamically shows the client's trading activity. The trade orders generated by the vendor module are presented on the source side and the trade orders being executed by the broker server are presented on the broker side. If the client indicated any setting or parameters that limit the automatic trading, only those trades satisfying the client's conditions are indicated on the source side. The client configures its settings on the settings page and configures its parameters on the systems and strategy page.

The settings page for the client, illustrated in FIG. 6B, is an abbreviated version of the settings page for the vendor module, illustrated in FIG. 6A. From the settings page, the client indicates the source information, broker information and operation conditions. For the source settings 610, the client selects from the vendor's trading systems and strategies supported by the associated vendor module. For the broker settings 612, the client identifies the broker with whom the client has an account (or a demonstration account). The client may also enable or disable automatic trading 613, audio alerts 614, lot multiplier 615, “buy” trades 616, “sell” trades 617, and auto set stop 618. The client can start 620, exit 621, or minimize 622 the display. (The settings are further described above with reference to FIG. 6A.)

After the settings are configured and the module started (including selection of vendor and trading system and indicating the broker platform), the client may monitor the transactions using the main activity display.

The main activity display, as illustrated in FIG. 3, applies to the client module, much the same way as applied to the vendor module. On the client's main activity display, the trade orders generated by the vendor's vendor module, applying the vendor's trading systems and satisfying the client's conditions, if any, are presented on the source side 310. As trades are automatically transmitted to the broker for execution they are displayed on the broker side 311 of the activity display.

In the illustrated embodiment, on the source side, the first column 312 is used to indicate whether a trade is enabled, disable, or blocked. Check mark (✓) indicates that the trade is allowed. Cross mark (×) indicates that the trade is not allowed. The client can enable or disable the trade order by double clicking on this mark to toggle between × and [symbol] . Circle mark ( [symbol] ) indicates that the trade is blocked by an opposing open position on the broker side and the trade is kept on the source side until the opposing position is cleared. U mark ( [symbol] ) indicates that the trade is blocked on the source side as a result of the client closing of an open position on the broker side. The client module and vendor module each allow for manual over-ride of any trades from the specified trading system. In addition, the trader or client may place manual trades, stops, limits, and change stops and limits directly from their respective modules.

The activity display indicates various other trade information, such as, identification number 313, currency pair 314, amount or units of currency per lot 315, either buy or sell action 316, the entry level price 317, an optional stop level 320, an optional limit level 322, the name of strategy or system 323 that generated the trade, and the status 324. The entry, stop and limit are each preceded by a field (317, 319, 321) in which the client can manually enable or disable these levels by indicating check mark ( [symbol] ) or cross mark (×). The status indicates which trade improvement features are activated. Status values include SS (soft start), FEE (forcing entry exit), ConsWL (consecutive win loss), and trailing, which are described in more detail below.

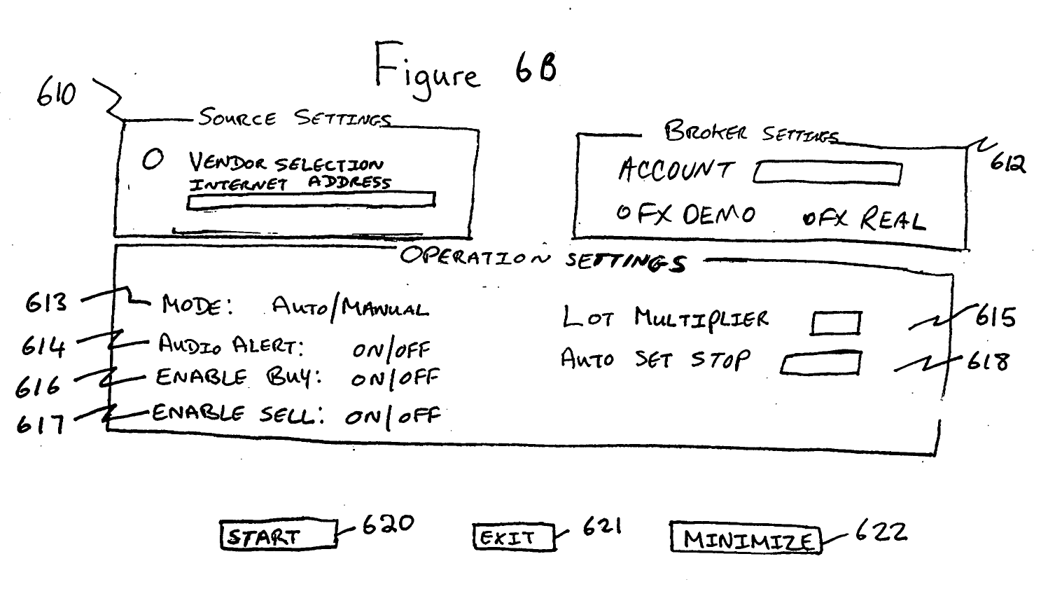

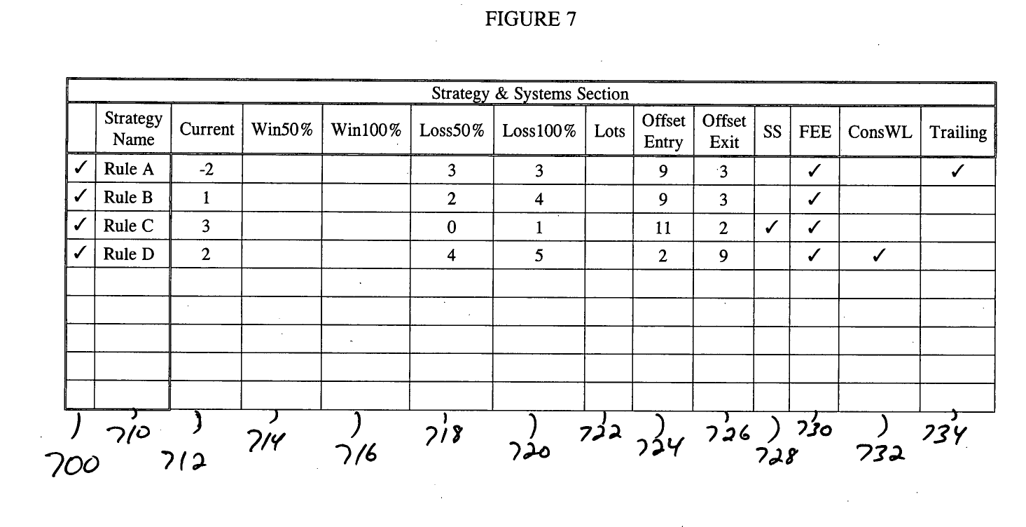

A client may defer all trading decisions to the vendor and vendor-provided strategies. However, the strategy and systems section, illustrated in FIG. 7, provides the client with the option of filtering the trade information from the vendor by imposing additional parameters.

For example, for each strategy or system, the client may indicate (at 700) whether the trade orders generated by the identified strategy or system (710) are to be executed automatically or manually. Manually means that the client must individually authorize or confirm the execution of those trade orders when they appear on the source side of the main activity display. When a check mark ( [symbol] ) appears in the field then all trades generated by that strategy are automatically transmitted to the broker platform. If a cross mark (×) appears then transmission of those trades is disabled.

The client may indicate the number of lots to be used per trade for each individual strategy. The Lots parameter 722 works in conjunction with the Lot Multiplier setting. The number of lots inserted in each individual strategy has priority over the lots setting. For example, if the Lot Multiplier is 2, meaning that all the trades transmitted by the client module will be using two lots, and the Lot parameter for a strategy indicates 3 lots, then all trades produced by this particular strategy will use 3 lots instead of 2.

The client may specify how a price difference should be treated. Some times the price quote provided by the data feed is different from the actual market price of the trade according to the broker at the time of the trade. This discrepancy can arise from the lapse of time between the price quote on the data feed and the time of executing the order or because the broker uses a data feed that is different (and presumably more reliable) than the one used for the charting program. The client specifications may be, for example, not to execute trades that encounter a price difference or only execute the trade if the price difference is less than a certain amount, or always execute the trade despite price difference, etc.

The FEE or Forcing Entry Exit (730) uses Offset Entry (724) and Offset Exit (726) parameters to handle price discrepancies. Offset Entry and Offset Exit define ranges to be applied in the event of a price discrepancy. The client may set each offset for some number of points. For an open position trade, if the difference between the broker (market) prices and data-feed/charting program prices is higher than the Offset Entry, then the client module will wait until the prices are within the prescribed range before executing the trade. Likewise to close a position, if the price discrepancy is greater than the Offset Exit, the client module will hold the trade until the discrepancy is reduced. For example if a EUR/USD Buy trade is generated at the price of 0.9900 and the dealing price of the broker at that moment is 0.9908, then if the Offset Entry is 11, the client module will accept that price and the position will be opened at the entry price of 0.9908. In this way any uncontrolled up or down movements in the charting program due to inaccurate price data can be avoided.

ConsWL (732) is a feature that considers trades that appear after a few consecutive losing trades as having a higher probability of being profitable. This is based on an analysis of the number of max consecutive losses. The variables involved are Current (712), Win50% (714), Win100% (716), Loss50% (718), and Loss100% (720). The Current field indicates the current number of consecutive winning or losing trades. A positive number is the number of winning trades and a negative number is the number of losing trades. Win50% indicates the number of consecutive wins where the number of wins is at least 50% of the current number of consecutive winning trades (indicated in the current field). Win100% indicates the number of consecutive wins where the number of wins is at least 100% of the current number of consecutive winning trades. Loss50% indicates the number of consecutive losses where the number of losses is at least 50% of the current number of consecutive losing trades. Loss100% indicates the number of consecutive losses where the number of losses is at least 100% of the current number of consecutive losing trades.

When the Current number is equal to the Win50% number then the number of traded lots increased by the Loss50% number will be reduced back to primary or basic number. For example, suppose that Current number is −2 (means two consecutive losses). In that case if the Loss50% parameter is also −2 then the client module will increase the number of basic lots by 50%. Suppose that the basic lots are 6, then the client module will increase the next trade by 3 additional lots that means all together 9 lots. These 9 lots will be active until current number reaches the Win50% number. After reaching that number, the lots will be reduced back to the basic 6 lots.

Likewise, when Current number is equal Win100% number then the number of traded lots increased by Loss100% number will be reduced back to primary or basic number. For example: Suppose that current number is −3 (meaning three consecutive losses). In that case if the Loss100% number is also −3, then the client module will increase the number of basic lots by 100%. Suppose that basic lots are 6, then the client module will increase the next trade with 6 additional lots, which means all together 12 lots. These 12 lots will be active until the Current number reaches the Win100% number. After reaching that number the lots will be reduced back to basic 6 lots.

When the ConsWL feature is enabled (checkmark), the client module will add or deduct lots to the basic number of lots accordingly. The lot adjustments are made assuming the client's account has sufficient balance to cover the trades and the required minimum margin.

SS or Soft Start (728) is the feature for avoiding a draw down when the client first starts trading on its account. If this feature is activated then the client module will not allow the trade to be transmitted until the first loss on that particular strategy has occurred. After that first loss, this feature is switched off and all the trades generated by the strategy are transmitted normally.

Trailing (734) is a feature that is used to enter the market at a better price. Just after the client module is activated there could already be an open position on the Source side. In that case, the client module compares the entry level with the dealing rates. If the trades can be entered in a better position then the client module will automatically execute the trade at the better position.

For example, if a USD/CHF Buy trade is already in the open position section on the Source side when the client first opens up the client module, and the entry level is 1.6700, the client module checks the current exchange rates for USD/CHF. If the current price to Buy is 1.6650, then that there is a chance to enter at 50 points better than the original entry. Therefore the client module will place an entry order at 1.6655 (5 points over the Buy level in accordance with Broker's allowance). There are two possibilities: (1) Market price is going to hit the new Entry level—thus, if the market moves up to the client's new Buy price of 1.6655 the trade will be triggered and the trade will move to the Open position section of the Broker side. (2) Market price is moving away from the new Entry level—thus, if the client's Buy price is not hit and the market price continues to move down, then the entry level will follow or trail it in the same direction and maintain 5 points difference until the client's entry is hit or the trade is cancelled. The opposite will occur for a Sell position.

The Entry Level Trailing feature may also be used while the client module operates. Continuing with the same example discussed above, there already is an order on the source side. If the current price is 1.6710 and the client is convinced that the Market price could drop below 1.6700, then the client can block the Trade on the Source side by use of Cross mark (×). In that case, the trade will not be transmitted by the client module when the Market price hits the Entry level. When the price has fallen enough, the client can just double click on Cross mark (×) and change it back to a check mark and the Trailing Entry level feature will switch on.

The system manager module is a program that creates optimum, trading systems from a collection of individual strategies. Various strategies are integrated into a single system to improve overall performance over individual strategies by balancing out the draw downs, thus smoothing out the equity curves, lowering risk capital, increasing return on the account, and optimizing account size. The system manager lists the individual strategies for the vendor to make a selection based on some specific criteria. The selected strategies are combines for performance review. When the vendor is satisfied with the overall system performance, the system may be further optimized based on the margin and desired level of risk for the system.

The system manager uses the data files generated by the trading strategies/systems within the charting program. The files contain all the information of a particular strategy and particular currency pair, regarding trading statistics and performances. Generally, the charting program files include information that is extraneous for the purposes of selecting a system and may be ignored. The system manager module provides a display that lists all the strategies, illustrated in FIG. 8, described above.

The strategies may be sorted in various ways, which ever is most useful for the investor, e.g., by strategy name, equity, maximum draw dawn, gross profit, number of trades, number of winning trades, number of losing trades, strategy profitability, and return on account. The investor marks the strategies that he thinks are the best combination for a cohesive trading system and gives the system a name for easy identification. The newly composed or modified trading system is analyzed for performance. This performance analysis is based on the application of the historical pricing data for some predetermined period. The performance analysis includes, e.g., total net profit, total number of trades, maximum draw down, percent profitable, minimal account deposit, annual return on account, and maximal capital risk. The trading system performance is also presented in various charts showing the development over time, e.g., equity, trades, draw down, and net profit. The investor may then try to optimize the trading system by adjusting the number of lots. To optimize, the system manager identifies the lowest profit months within the total trading period and increases the lot number for the strategies which show the best performances during the months of low profit. The procedure is repeated until the profit no longer changes or increases. If the investor is satisfied with the trading system, the system manager module prepares the trading system in the appropriate final format for use with the charting program and vendor module. Typically investor's who develop trading systems are vendors. To make the trading system available to clients, the finalized trading system is posted at the vendor's system summary.

When strategies are combined into trading systems internal conflicts are generally resolved within the trading system. However, if conflicting trades are nevertheless proposed or if a conflict arises between the trades proposed by different systems or strategies operating concurrently, the vendor module handles the conflict and blocks the inconsistent trade order. The vendor module considers buy and sell orders separately and in the sequence in which they are generated which helps prevent execution of conflicting orders. For example, consider a 30-minute-chart strategy produces a buy order while the 60-minute-chart strategy produces a sell order for the same currency. All generated trades from strategies within the charting program are transmitted to the source part of the Vendor module. The vendor module takes the first trade that comes through. If an opposing trade is generated, the vendor module recognizes that there is an opposing trade already entered and it will hold the 60 minute sell order until the first order hits its limit or stop. The conflicted trade being held is marked with a circle sign in front of the trade. When the conflict is cleared, the vendor module checks whether the sell order is still on the source side. If the sell order is still on the source side and the market price is at the original entry price or better, the trade is executed. Otherwise the vendor module will continue to hold the trade in the source side until it is entered or canceled by the trading system. The period of the strategy has no influence on this. The buy/sell strategies can also be separated into independent buy and sell strategies and re-combined into a variety of combinations to produce various systems.

With the vendor module, development tools are optionally provided to support a scripted language for incorporating additional strategies and modifying trading system parameters. This high level programming language, e.g., based on Visual Basic, enables the trader or vendor to easily add and change conditions for processing orders independent of what the mechanical system generates. A group of commands and functions are provided for the trader to use to compose his individual requirements without making any changes to the previously (separately) coded trading systems. The commands and functions are designed for trading purposes inside the vendor module.

In this way a trader can use the scripted language to program and incorporate custom filters into the vendor module functionality. For example if a trader wants to change some of the logic inside the FEE mode. He would like to add, cut or change some parts of the decision process of this feature. By use of already existing commands and functions within the scripting language of the Vendor module, he could simply copy and paste his changes inside the program structure, then change, replace, delete or add part of the program according to his objectives. The new function of FEE will be different than it was from the original. There is no need to contact the system developer to change the program or trading system code in the charting software. He can just make the changes in the scripting language within the Vendor module in accordance with his individual wishes.

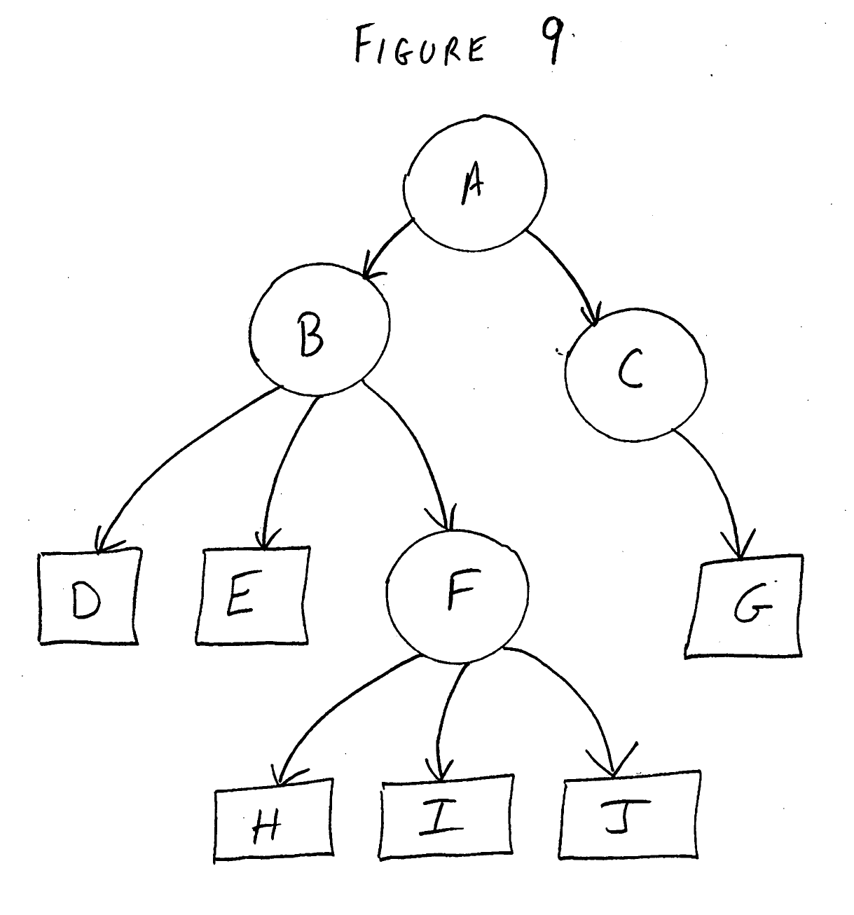

Vendors, who provide investing services, charting programs and/or trading strategies/systems, using the vendor module, may have many clients using the client modules. In addition, some vendors may be acting as a client with respect to another vendor, resulting in a (tree-structure) network. For example, as illustrated FIG. 9, one vendor A using a vendor module has two sub-vendors B and C. Sub-vendor B has two clients D and E and its own sub-vendor F. Sub-vendor F has three clients H, I, and J Sub-vendor C has one client G.

The control module provides a way to keep track of a network of clients, sub-vendors, and vendors, and their respective trading activities. For purposes of discussion, the entity exerting this control (using the control module) is referred to as the super-vendor. Using the control module, the super-vendor can help its vendors and clients in the event of technical difficulties, chat with them, and when a contract expires, terminate the vendor or client's access privileges, among other things.

In addition, this system can keep track of all commissions or fees between the various vendor, subvendor and client modules, thus making the vendor module a suitable tool for entrepreneurs and joint venture marketing. For example the super-vendor may view information about each sub-module (vendor modules and client modules), including current activity status and settings, etc. The control module obtains this information from each sub-module. The control module may also track and obtain diagnostic information in the event of some technical failure or error.

As implemented in a business environment, typically clients are charged a fee for the trading services provided. Where the fee is based on individual trades, keeping an accounting can be very difficult due to the potentially frequent and large number of transactions. Therefore, an integrated tracking and payment procedure is implemented along with the trading technology. Each trade communication with a broker server for a participating broker is accompanied by an identification code that indicates the fee structure for that transaction including, e.g., the parties involved, to whom fees are due and the amount of the fees.

For example, the identification code may be comprised of the following information: an identification of the module making the trade (e.g., client, sub-vendor, vendor, etc); the account or agreement number of the module making the trade; the account or agreement number of the supervisory module (e.g., sub-vendor or vendor); the amount of the commission or fee to be charged to the account of the module making the trade; the amount of the fee to be credited to the supervisory module; and optionally the amount of the fee to be credited to a third party vendor. The optional third fee amount is used when the commission is to be split between the supervisory module and a third party, e.g., the charting program vendor. This fee may be non-transparent to the client. For example, if F has account number 12333, and B has account number 11880, then ID code of TRM-12333-11880-10-6-4, means that the broker server will charge F's account 12333 with a transparent fee of $10, credit B's account 11880 with a $6 transparent fee and credit the third party (e.g., A or charting program vendor) with a $4 non-transparent fee. Using this system, a fee or commission agreement could be structured and tracked in numerous ways.

As many different embodiments, variation, and modification of this invention may be made without departure from the spirit and scope thereof, it is to be understood that the invention is not limited to the specific embodiments thereof except as defined in the appended claims.

What is claimed is:

1. A method to facilitate automatic trading in a financial market using a vendor module with an operating trading strategy to service one or more client modules, comprising the following steps all performed in real time:
(a) receiving an input of dealing rates at the vendor module;
(b) applying the trading strategy operating in the vendor module to the dealing rates to generate trade orders; and
(c) transmitting trading information including the trade orders from the vendor module to a server module; and
(d) receiving the trading information from the server module in at least one of the client modules;
(e) the at least one of the client modules selecting one or more of the trade orders from the trading information based on predetermined client settings; and
(f) transmitting the selected trade orders from the at least one client module to a broker server for execution.

2. The method of claim 1 further comprising the steps performed by the vendor module of accessing a database of historical trading information including past dealing rates and past trade orders; and using at least part of the historical trading information to apply the trading strategy to generate the trade orders.

3. The method of claim 1 further comprising the step of the vendor module applying predetermined vendor settings to the trading strategy for generating the trade orders.

4. The method of claim 1 further comprising the steps of
(a) the vendor module transmitting the trading information including trade orders to the broker server for execution;
(b) a website module receiving from the vendor module trading information that includes trade orders and the result of executed trade orders; and
(c) the website module formatting a display of the trade orders generated by the vendor module and result of the executed trade orders.

5. The method of claim 4 further comprising the steps of
(a) The website module receiving from the vendor module historical trading information including data showing the performance of the trading strategy; and
(b) The website module formatting a second display of the historical trading information.

6. The method of claim 1 further comprising the following steps performed in real time by a subvendor module with a second trading strategy:
(a) receiving from the server module the trading information that includes the trade orders generated by the vendor module;
(b) receiving a streaming input of dealing rates;
(c) applying the second trading strategy to the dealing rates and the trade information to generate subvendor trade orders; and
(d) transmitting subvendor trading information including subvendor trade orders from the subvendor module to the server module.

7. The method of claim 6 further comprising the following steps preformed in real time and independently by each of one or more subclient modules serviced by the subvendor module:
(a) receiving the subvendor trading information from the server module;
(b) selecting one or more subvendor trade orders from the subvendor trading information based on predetermined subclient settings; and
(c) transmitting the selected subvendor trade orders to the broker server for execution.

8. In the method of claim 1, the client settings include one or more of the following:
(a) a default number of units to be used for each of the trade orders generated by the vendor module;
(b) a number of points that would trigger a stop in trade orders;
(c) specifying a permissible range of price discrepancy;
(d) enabling or disabling automatic transmission to the broker server of the trade orders generated by the vendor module;
(e) enabling or disabling automatic transmission to the broker server of the trade orders to buy; and
(f) enabling or disabling automatic transmission to the broker server of the trade orders to sell.

9. In the method of claim 1, the vendor module applies a plurality of trading strategies to the dealing rates to generate the trade orders and the client settings include one or more of the following:
(a) a number of units to be used for each of the trade orders generated by the vendor module based on a specific one of said plurality of trading strategies;
(b) enabling or disabling automatic transmission to the broker server of the trade orders generated by the vendor module based on a specific one of said plurality of trading strategies; and
(c) specifying a number of consecutive win transactions or consecutive loss transactions that trigger an increase or decrease in the number of units per trade order generated by the vendor module based on a specific one of said plurality of trading strategies.

10. A system for automatically generating trade orders on a vendor account and one or more client accounts, the system comprising
(a) a vendor module that uses an input of real-time dealing rates and at least one trading strategy to generate vendor trade orders for the vendor account;
(b) a server module that receives a signal representing vendor trading information including the vendor trade orders from the vendor module and transmits a signal representing the vendor trading information to one or more client modules; and
(c) each of the one or more client modules that applies its predetermined settings to the received vendor trading information to select vendor trade orders for its client account.

11. The system of claim 10 further comprising
(a) a subvendor module that receives the signal representing the vendor trading information from the server module, uses the vendor trading information along with an input of real-time dealing rates and at least one second trading strategy to generate subvendor trade orders, and transmits a signal representing subvendor trading information including the subvendor trade orders to the server module; and
(b) one or more subclient modules that each receives the signal representing the subvendor trading information including the subvendor trading orders; and applies its predetermined subclient settings to the received subvendor trading information to select subvendor trade orders for its subclient account.

12. The system of claim 10 further comprising the vendor module that transmits to a website module a first signal representing the vendor trade orders and a second signal representing historical trading information for the at least one trading strategy; and the website module that receives the first signal and second signal, formats a display of the vendor trade orders, and formats a second display of the historical trading information.

13. A method for automated trading in a financial market on a client account with a remotely located broker platform comprising the steps of
(a) receiving in real-time trading information that includes trade orders generated by a remote module that applies a trading strategy to real-time dealing rates;
(b) transmitting in real-time the trade orders to the remotely located broker platform for execution on the client account.

14. The method of claim 13 further comprising the steps of
(a) applying in real-time predetermined client settings to the trading information to select from the trading information those trade orders that comport with the client settings; and
(b) transmitting in real-time the selected trade orders to a remotely located broker platform for execution on the client account.

15. The method of claim 14 further comprising the steps of
(a) formatting a display of the trade orders and executed trade orders;
(b) receiving updated client settings; and
(c) applying in real-time the updated client settings to the trading information to select from the trading information those trade orders that comport with the updated client settings.

16. A system for automated trading in a financial market on a client account with a remotely located broker platform, the system comprising:
(a) an input for receiving real-time trading information that includes trade orders;
(b) a processor for applying predetermined client settings to the trading information to select those trades that comport with the client settings; and
(c) a transmitter for automatically sending the selected trade orders to the remotely located broker platform for execution of the selected trade orders on the client account.

17. A method for generating trade orders in a financial market, comprising the steps of:
(a) establishing access to real-time dealing rates;
(b) setting up a plurality of trading strategies;
(c) applying the plurality of trading strategies to the dealing rates to generate one or more proposed trade orders; and
(d) coordinating the proposed trade orders by suspending any of the proposed trade order that conflicts with a previously accepted trade order.

18. The method of claim 17 further comprising the step of automatically transmitting to a broker server trading information including the accepted trade orders for execution on a predetermined account.

19. A method for a vendor to service one or more clients interested in trading in financial markets comprising the steps of
(a) generating trade orders using a charting program;
(b) formatting a display accessible by the one or more clients, the display showing the trade orders;
(c) detecting execution of a trade order on a predetermined account with a broker server; and
(d) updating the display to show the executed trade and if the executed trade creates an open position to show the open position.

20. The method of claim 19 further comprising the steps of using at least one predetermined trading strategy to generate the trade orders; storing historical trading information including the trade orders and the executed trades; and upon request from one of the clients, formatting a second display showing the performance of the at least one trading strategy using the stored historical trading information.

21. A system for generating trade orders in a financial market comprising
(a) an input for accessing real-time dealing rates;
(b) a processor for applying a plurality of trading strategies to the dealing rates to generate one or more proposed trade orders and for coordinating the proposed trading orders by suspending any of the proposed trade orders that conflicts with a previously accepted trade order;
(c) a means for detecting execution of an accepted trade order; and
(d) a database for storing trading information including accepted trade orders and executed trade orders.
